(19) United States
(12) Patent Application Publication
(10) Pub. No.: US 2011/0296643 A1
(43) Pub. Date: Dec. 8, 2011

(54) PHOTOCATALYSIS PROCESS TOOTHBRUSH

(75) Inventors: Benjamin Gregory SHEPHERD, Fruitland Park, FL (US); Charlene Adele BARNES, Dunnellon, FL (US)

(73) Assignee: TECHLIGHT SYSTEMS LLC, Dunnellon, FL (US)

(21) Appl. No.: 13/195,362

(22) Filed: Aug. 1, 2011

Related U.S. Application Data
(63) Continuation-in-part of application No. 12/252,876, filed on Oct. 16, 2008.
Application No. 12/252,876 is a continuation-in-part of application No. 11/946,263, filed on Nov. 28, 2007, now abandoned.
(60) Provisional application No. 60/872,761, filed on Dec. 4, 2006.

(51) Int. Cl. A46B 15/00; B23P 17/04

(52) U.S. Cl. 15/167.1; 300/21

(57) ABSTRACT

A photocatalysis process light emitting toothbrush comprising a handle with a grip at a proximal end and a replaceable brush head at a distal end thereof. The replaceable brush head has at least one group of bristles permanently affixed to the replaceable brush head and at least one violet light emitter is provided on an upper surface of the replaceable brush head for emitting violet light in a direction generally parallel to the bristles permanently affixed to the replaceable brush head. At least one violet light source is provided for radiating violet light, in a wavelength band between 400 nm to 420 nm, and a power source is provided for energizing the at least one violet light source. The violet light is at least one of modulated emission with an average optical output power level of less than 5 watts.

### CROSS REFERENCES TO RELATED APPLICATIONS

This application is related to and is a continuation-in-part of U.S. patent application Ser. No. 12/252,876 filed on Oct. 16, 2008 which is related to and is a continuation-in-part of U.S. patent application Ser. No. 11/946,263 filed on Nov. 28, 2007 which claims the benefit of U.S. Provisional Patent Application No. 60/872,761 filed on Dec. 4, 2006 and such teachings and disclosures are hereby incorporated by reference.

### FIELD OF THE INVENTION

The present invention relates to dental hygiene and, in particular, to either a light emitting manual or an electrically operated semiautomated toothbrush which emits radiation, near ultraviolet region of the electromagnetic spectrum, in order to oxidize and destroy potentially harmful bacteria and/or other contaminants or compounds contained within the mouth without harming or destroying human cells and also activate a photo catalyst that may be deposited on the teeth and the gums of the person utilizing the toothbrush during normal brushing.

### BACKGROUND OF THE INVENTION

The use of photocatalysis in dental hygiene processes is well established and stems from processes for purifying gases and liquids and for controlling bacteria and other microorganisms in gases and liquids and on the surfaces of solid objects. In general, photocatalysis methods involve the photoexcitation of photocatalytic compounds, for example, catalytic n-type semiconductor particles such as TiO₂ particles, with ultraviolet (UV) light to activate the photocatalyst, which then participates in reduction/oxidation reactions with matter adsorbed to or in the near vicinity of the surface of the particles. The reduction/oxidation reactions produce highly reactive hydroxyl radicals which oxidize and destroy bacteria and organic compounds in the gas or liquid or on the surface(s) being treated, such as bacteria and other organic substances associated with, for example, tooth decay, gum disease, denture stomatitis and halitosis/malodor.

In the past, photocatalysis methods have generally only been performed in a dentist's offices by either a dentist or a dental hygienist using a specialized UV laser(s) or some other optical device(s) which emits a controllable, directed beam of UV light. More recently, however, there have been proposals to manufacture and sell UV photocatalysis devices to the general public, e.g., a toothbrush containing a UV light radiating device, together with toothpastes and/or mouthwashes containing photocatalytic particles, such as TiO₂. In such toothbrushes, the UV light emitted by a UV laser diode, for example, passes through a light guide to the end of the toothbrush which brushes the teeth where this light is emitted into the user's mouth by, for example, lenses implanted among the bristles or through fiber optic bristles that form at least part of the brush bristles. The bristles mechanically facilitate removal of plaque and/or other organic materials from the teeth and the gums during brushing, similar to brushing with a conventional toothbrush, while the UV light is emitted directly to illuminate photocatalytic particles distributed on the surfaces of the teeth and the gums, thereby providing both a conventional cleaning mechanism as well as a photocatalytic cleaning mechanism.

The currently UV photocatalytic toothbrushes which are marketed to consumers, however, have a number of significant problems, not the least being the potential hazards associated with such devices. For example, in the generally preferred wavelength range of 280 mm to 400 mm, UV light at any power level is typically capable of damaging human skin including the tissue of human eyes. Compounding this problem is the fact that UV light within this wavelength range is nearly invisible to a user or patient, so that it is difficult to determine where the emitted UV beam is directed or aimed. In addition, the duration of irradiation of the catalytic particles, at any particular location within the mouth, is typically very short during the normal toothbrushing process, thus requiring higher power levels of UV radiation in order to obtain effective catalytic reactions. This problem is further compounded by the normal deterioration of the light transmission capability of the brush end elements, such as the lenses and the fiber optic elements, over time. Higher emitted power levels are generally called for in order to achieve satisfactory performance.

Up until now it is in fact the potential hazards of UV radiation that has limited the use of the UV dental hygiene processes to dentists and oral hygienists and the practical application of these methods to consumer toothbrushes and devices accordingly faces significant hurdles. For example, all medical or dental devices emitting ultraviolet light, and in particular within the wavelength range of 280 mm to 400 mm, are under Food and Drug Administration (FDA) control and licensing. In addition, all laser devices emitting coherent radiation of 1 milliwatt or more in the visible wavelengths, and all devices emitting laser radiation at any power level in the non-visible wavelengths, such as the UV and IR wavelengths, are presently prohibited from being sold to the general public.

Still a further problem with light emitting toothbrushes and other devices employing high power light emitting diodes was that these high power light emitting diodes require very special electronically controlled constant current circuitry. Such control circuitry has only recently been available in the form of an economical integrated circuit. Failure to use electronically controlled constant current circuitry to drive a high power light emitting diodes, will result in uncontrolled light output, degraded high power light emitting diode performance, and possible catastrophic failure.

A further problem with the proposed light emitting electric toothbrushes employing movable bristle segments, while this seems to be a logically sound idea, the electro mechanical requirements necessary to completely seal the light emitting diode and control electronics from any moisture intrusion, make this electric toothbrush idea with movable bristles impossible to economically manufacture and sell as a commercially viable product.

The present invention, however, provides a solution to the above described as well as other related problems associated with the prior art products and methods.

### SUMMARY OF THE INVENTION

Wherefore, it is an object of the present invention to overcome the above mentioned shortcomings and drawbacks associated with the prior art.

A primary object of the invention is to provide a light emitting toothbrush which emits radiation, near ultraviolet region of the electromagnetic spectrum, to oxidize and destroy potentially harmful bacteria, microorganisms and/or other contaminants or compounds without harming or destroying human cells contained within the mouth.

Another object of the invention is to provide a light emitting toothbrush that will activate a photo catalyst deposited on the teeth and the gums of the person utilizing the light emitting toothbrush during normal brushing.

A further object of the invention is to provide a light emitting toothbrush which emits violet light within the 380 nm to 450 nm wavelength band, of the electromagnetic spectrum, more specifically emitting violet light having a wavelength of about 410 nm±10 nm so as to generally avoid the normal hazards associated with using UV radiation as well as the corresponding FDA restrictions.

Yet another object of the invention is to provide a light emitting toothbrush in which the radiated violet light emissions may be amplitude modulated from 0% to 100% at a frequency of between about two (2) and about two hundred (200) Hertz, more preferably between about 6 and about 60 Hertz and most preferably between about 10 and about 30 Hertz, with an average optical output power level of less than 5 watts.

A still further object of the invention is to provide a light emitting toothbrush which is relatively inexpensive to manufacture which has a power source that is light weight and can be readily recharged or replaced as needed.

Another object of the invention is to provide a manual or an electrically driven light emitting toothbrush which is highly effective in destroy potentially harmful bacteria, microorganisms and/or other contaminants or compounds contained within the mouth while being relatively harmless to the eyes and the skin the user of the toothbrush.

Yet another object of the present invention is to provide a toothbrush having a handle with a neck permanently affixed thereto with a light source embedded in an upwardly facing surface of the neck of the toothbrush with a replaceable brush head having an aperture formed therein which is aligned with the light emitting diode once the replaceable brush head is installed on the remote end of the neck.

A further object of the present invention is to ensure that the lighting emitting diode, as well as all the remaining electrical components of the toothbrush, are permanently sealed with respect to the external environment so as to prevent any water, moisture, toothpaste and/or other contaminants from entering into an interior compartment or area of the neck or the toothbrush and causing a malfunction of the toothbrush.

Still a further object of the present invention is to provide a replaceable brush head which has an aperture provided therein with the aperture being designed so that it is slightly larger than the emitting surface of the light emitting source so that, when the replaceable brush head is installed on the remote end of the neck, the aperture is concentric with and aligned with the light emitting diode to allow all of the light to pass through the brush head and interact with the teeth end or gums of the patient during brushing.

As used herein, the term “average optical output power level” means that the optical output power may briefly exceed 5 watts on modulation peeks how ever the total integrated power level over a time period of 1 second will not exceed 5 watts.

### BRIEF DESCRIPTION OF THE DRAWINGS

The invention will now be described, by way of example, with reference to the accompanying drawings in which:

FIG. 1 is a diagrammatic perspective view of a toothbrush according with the teachings of the present invention;

FIG. 2A is a diagrammatic transverse cross sectional side view of the toothbrush of FIG. 1;

FIG. 2B is a diagrammatic transverse cross sectional side view of the toothbrush of FIG. 1;

FIG. 3A is an enlarged diagrammatic side elevational view of a brush head with the violet light source extending further away from the base of the head, then the embodiments of FIGS. 2A and 2B, so that the light is emitted adjacent the free ends of the bristles of the toothbrush;

FIG. 3B is a diagrammatic transverse cross sectional side view of an alternative embodiment of a toothbrush which comprises a handle having a removal brush head;

FIG. 3C is a diagrammatic transverse cross sectional side view of an alternative embodiment of a toothbrush in which the handle is integral with the brush head;

FIG. 3D is a diagrammatic enlarged view of the brush head of FIG. 3C;

FIG. 4A is a diagrammatic enlarged view of an alternative embodiment of the brush head in which each individual violet light source is associated with a group of bristles attached to the brush head to supply the violet light along the length of the bristles;

FIG. 4B is a diagrammatic enlarged view of a further embodiment of a brush head having each violet light source associated with a group of bristles attached to the brush head;

FIG. 5 is a diagrammatic exploded view showing assembly of a completely toothbrush which has a replaceable brush head;

FIG. 5A is a diagrammatic side elevational view showing the assembled completely toothbrush with the replaceable brush head;

FIG. 5B is a diagrammatic cross sectional view of the assembled completely toothbrush of FIG. 6A prior to installation of the replaceable brush head;

FIG. 6 is a partial diagrammatic exploded perspective view showing the assembly the neck to the handle and assembly of the circuit driver within a base section of the handle;

FIG. 7 is a diagrammatic top plan view showing of the neck of the completely toothbrush prior to installation of the replaceable brush head;

FIG. 7A is a diagrammatic side elevational view of the neck of FIG. 7;

FIG. 8 is a diagrammatic top plan view of the replaceable brush head for attachment to the neck;

FIG. 8A is a diagrammatic left end elevational view of the replaceable brush head of FIG. 8;

FIG. 8B is a diagrammatic bottom plan view of the replaceable brush head of FIG. 8; and

FIGS. 9A, 9B, 9C and 9D respectively are tables showing the effectiveness of various frequencies of blue and violet light in killing common bacteria found in the mouth of a human.

### DETAILED DESCRIPTION OF THE INVENTION

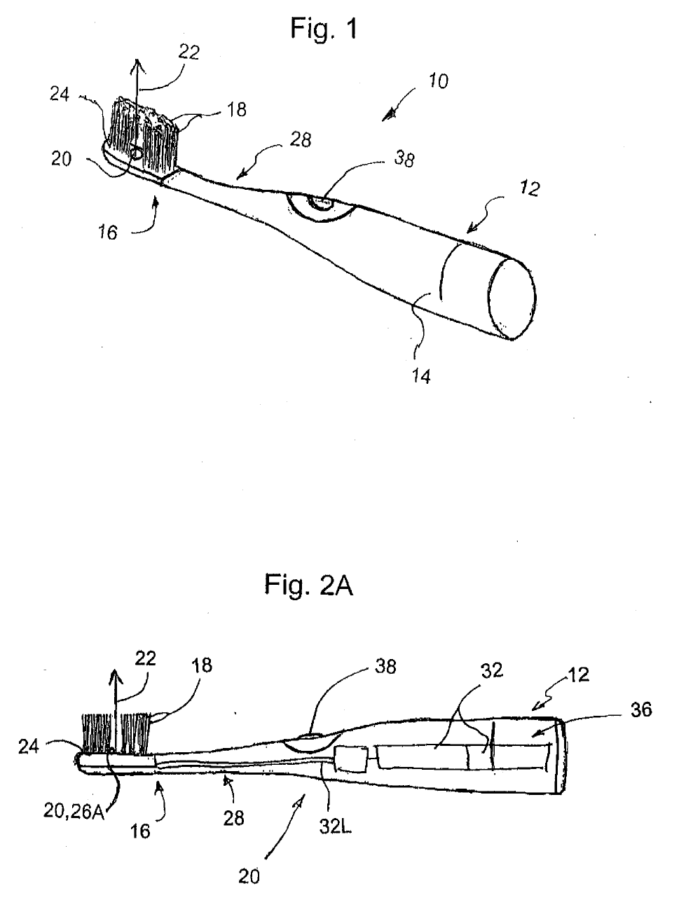

Turning now to FIG. 1, a diagrammatic representation of a toothbrush 10, according to the present invention, is shown. As illustrated therein, the toothbrush 10 includes a handle 12 having a grip 14 at its proximal end to be held in the user's hand while using the toothbrush 10 and a brush head 16, typically including one or more groups of bristles 18, located at the distal or working end of the handle 12. As also illustrated in FIG. 1, the head 16 further includes one or more violet light emitters 20 that emit violet light 22 in the 410 nm+/−10 nm (nanometer) wavelength band, that is, in the wavelengths generally between 400 nm and 420 nm and at an average power level of less than 5 watts. Preferably the violet light has an average power level of between about 0.25 and about 1 watt and more preferably an average power level of between about 0.5 and about 0.95 watts. The inventors have found that emitting violet light within this wavelength is highly effective in destroying potentially harmful bacteria, microorganisms and/or other contaminants or compounds without harming or destroying human cells contained within the mouth. In particular, the inventors have discovered that using violet light 22 between 400 nm and 420 nm and at an average power level of less than 5 watts is more effective in destroying potentially harmful bacteria, microorganisms and/or other contaminants or compounds than wavelengths outside range.

An important aspect is to always have the bristles 18 affixed to the brush head of the toothbrush. In addition, the light emitting source or diode 26A can be either fixed and sealed to the brush head 16 adjacent the bristles 18, alternatively, the light emitting source or diode can be fixed and sealed with respect to the neck 26 of the handle 12.

In some applications, the violet light output from the emitters 20 may comprise solely a continuous emission of violet light having a combined power level of less than 5 watts, while in other applications the violet light output from the emitters 20 may comprise a modulated violet light emission having a frequency of between about two (2) and about two hundred (200) Hertz, more preferably between about 6 and about 60 Hertz and most preferably between about 10 and about 30 Hertz, having an average combined power level of less than 5 watts. For other applications, the violet light output from the emitters 20 may comprise a first violet light component which is a continuous emission of violet light and a second violet light component which is a pulsed violet light emission at a frequency typically between two (2) and two hundred (200) Hertz a few Hertz and a few hundred Hertz, more preferably between about 6 and about 60 Hertz and most preferably between about 10 and about 30 Hertz. For such combined continuous and pulsed violet light emission, the combined total emission must not exceed an average output which is greater that 5 watts. It is to be appreciated that the 400 nm to 420 nm wavelength band is within the visible “violet light” portion of the electromagnetic spectrum and is, therefore, above the UV light spectrum normally employed during conventional dental hygiene processes conventionally carried out by dentists and dental hygienist, thereby avoiding the normal hazards associated with using UV radiation as well as the corresponding FDA restrictions.

The presently preferred photocatalytic agents, for use with radiation within the 400 nm to 420 nm “violet light” band include, for example, modified TiO₂ semiconductor type materials and possibly other catalytic n-type semiconductor particles as well as various organic dyes already known in the art as being photocatalytically responsive to violet light radiation.

As illustrated in FIGS. 1, 2A, 3A and 3B and as will be described further in the following description, the violet light emitters 20 emit violet light 22 in a direction generally perpendicular to an upper surface 24 of the head 16 thereby to radiate the violet light 22 into the mouth cavity of the person brushing his or her teeth, that is, the violet light is generally directed toward the teeth, the gums, and the tongue, being contacted by the bristles 18 as the toothbrush is used to brush the teeth. The violet light emitters 20 may comprise one or more violet light sources 26A, such as violet light emitting diodes or violet light emitting organic light emitting diodes, or any other type of violet light emitting device located either on, within or partially recessed within the upper surface 24 of the head 16 to facilitate directly emitting the violet light 22. Alternatively, the violet light source(s) 26A may be located within the body of the head 16 or within handle 12 with the violet light 22 being conducted along the handle and/or body to the violet light emitters 20 where the violet light is finally emitted. One or more internal passages or light conductive elements, such as reflective surfaces, violet conductive fiber optics, lenses and/or any combination thereof are provided in the handle and/or body to facilitate transmission of the violet light to the violet light emitters 20. In such embodiments of a toothbrush 10, the violet light source or sources 26A will be described or defined as being located contiguous to the head 16, such, as at the top surface 19 of head 16 or within the body of head 16, and it should be noted that for purposes of the present descriptions, the term “contiguous” is taken as meaning “in physical contact with” or “near, next to, or adjacent”.

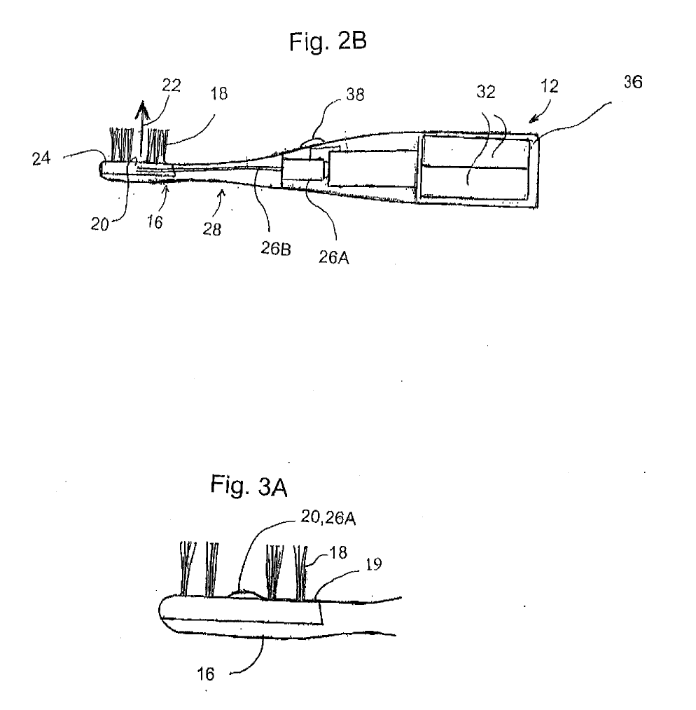

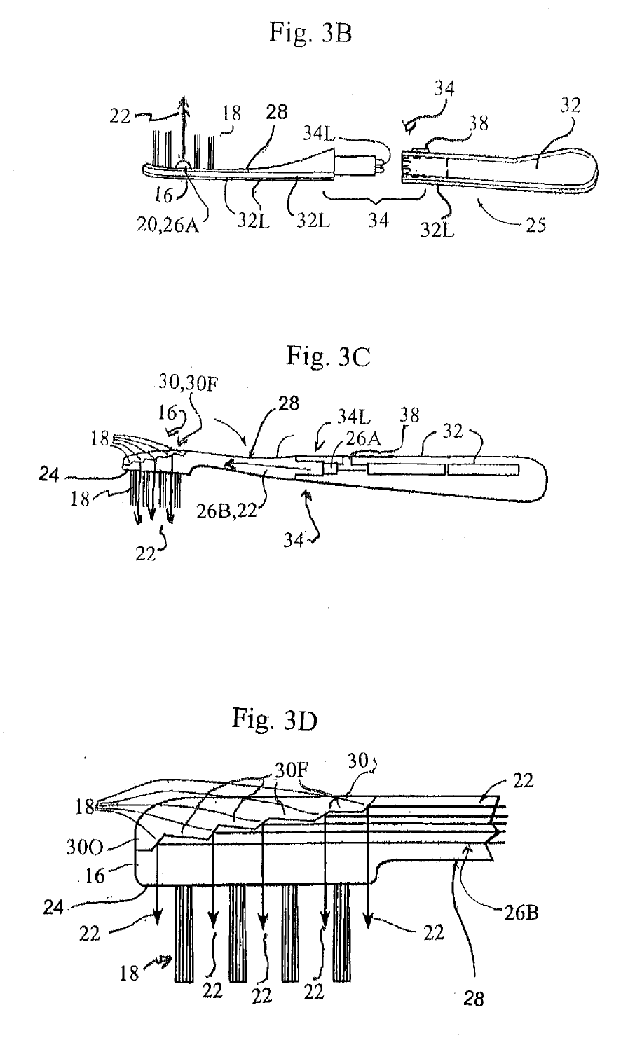

In other embodiments, such as is illustrated in FIGS. 2B, 3C and 3D, the violet light source or sources 26A may be located non-contiguously with head 16, such as in handle 12, with the violet light 22 being conducted along the handle to violet light emitters 20 located within the head 16 by means of violet light optical conductors 26B comprising, for example, of violet conductive fiber optic elements or lenses, reflective surfaces, passages or conductive “pipes” comprising violet conductive materials, and/or any combination thereof, which form a one or more paths that conduct the violet light 22 from the violet light source or sources 26A to the violet light emitters 20 where the light is emitted.

For example, one or more violet light sources 26A may be located in handle 12 at a position just below a neck 28, formed at a junction between the handle 12 and the head 16. According to one exemplary embodiment, such as illustrated in FIGS. 3C and 3D, the neck 28, the head 16 and possibly portions of the handle 12 are constructed, for example, of a violet transparent material or with one or more violet transparent passage(s) or violet light conductive “pipe” which facilitate passage of the violet light 22 through the neck 28 to the head 16 and thereafter radiated from the violet light emitters 20. In the embodiment illustrated in FIGS. 3C and 3D, the portions of the neck 28 through which violet light 22 is transmitted comprises a suitable violet transparent material, as does the body of the head 16. The interior of head 16 includes a violet reflective surface 30 formed as facets 30F wherein the violet light reflective properties of reflective surface 30 is formed, for example, by a coating applied at least between the surfaces of facets 30F and an over-mold 300 of a different material forming the back regions of the head 16. The reflective surface 30 may also be formed, for example, by the optical interface of the body 16 and the over-mold 300 materials in the region of facets 30F.

As indicated in FIGS. 3C and 3D, the violet light 22 passing through neck 28 is reflected by facets 30F and redirected by the facets 30F from an arrival path, supplied along and co-linear with the neck 28, to a direction generally parallel to the bristles 18, that is, to and through the upper surface 24 of the head 16. It should be noted with regard to this embodiment that other scattering of the violet light 22 in other directions, such as through the distal end of head 16, would provide catalytic activity in other areas of the mouth, but would require attention during design to avoid unwanted emissions of violet light from toothbrush.

It will be recognized that the reflection of the violet light from its arrival path from handle 12 to the direction parallel with the bristles 18 may also be accomplished by curved or flat surfaces, rather than by faceted surfaces.

In an alternate embodiment, as illustrated in FIG. 2B, the violet light source or sources 26A are again located in the handle 12 which illuminate the violet light emitters 20 provided in the head 16, via a violet light conductive path, wherein the violet light conductive path comprises violet light optical conductors 26B including, for example, violet conductive fiber optic elements or lenses, tunnel-like passages or conductive “pipes” comprising violet conductive materials and/or any combination thereof.

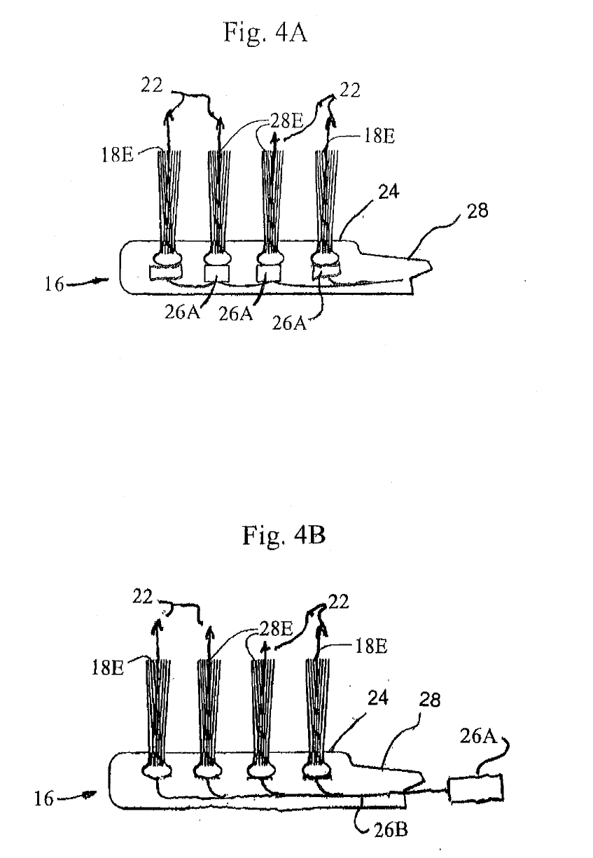

Turning now to the bristles 18, it has been described above that the bristles 18 may comprise either conventional bristles 18, such as found in conventional toothbrushes, and the violet light 22 may be radiated the from violet light emitters 20 located on or in the top surface 24 of the head 16, as was discussed above. In other embodiments, however, the violet light emitters 20 in or on the top surface 24 of the head 16 may comprise wholly, or in part, violet light emitting bristles 18E containing a violet light conductive material. As illustrated in FIG. 4A, the violet light source of sources 26A may be located either in the head 16, at the bases of emitting bristles 18E, to illuminate emitting bristles 18E directly, or, as illustrated in FIG. 4B, may be located in handle 12 with the violet light 22 being conducted to the bases of the emitting bristles 18E by violet light optical conductors 26B. In the latter case, the emitting bristles 18E may comprise the same material as the violet light optical conductors 26B or may be continuations of the violet light optical conductors 26B. It should also be noted that the emitting bristles 18E may be coated or otherwise provided with a reflecting outer surface to prevent or minimize the loss or escape of the violet light 22 out through the sides of the emitting bristles 18E, and the head 16 may likewise be provided with a reflective violet light containment surface to prevent or minimize leakage or loss of the violet light 22.

It will be noted from the above descriptions of the light emitting toothbrush 10 that while the violet light emitters 20 are located in or on the head 16, the violet light source or sources 26A may be located either in the head 16 or in the handle 12. In one instance, therefore, violet light 22 must be conducted from the violet light source or sources 26A located within the handle 12 to the head 16 and, in the other instance, electrical power, such as from a battery 32, must be conducted from the handle 12 to the head 16 for supplying electrical power to the violet light source or sources 26A. It must also be noted, however, that in certain implementations, such as those illustrated in FIGS. 2B, 3C and 3D for example, the neck 28 which is formed between the head 16 and the handle 12 may form a disconnectable junction or connection 34 between the head 16 and the handle 12 to allow the head 16 to be removed from the handle 16. This is a common feature in many conventional toothbrushes, particularly in conventional battery powered toothbrushes wherein a battery 32 and an electric motor vibrate or rotate the toothbrush head. This design facilitates replacement of a worn or old head 16 with a new head 16 or a different head 16 having, for example, a different function, a different arrangement, a different type of bristles 18, etc.

In those instances wherein the violet light source or sources 26A are located in handle 12, the path between the violet light source or sources 26A and the head 16 will include the appropriate violet light optical connectors 34L, at junction 34, to allow the optical path to be repeatedly disconnected and reconnected in a reliable manner. Connectors 34L may, for example, comprise lenses, fiber optic connectors or appropriately shaped ends in those implementations wherein the optical light path comprises the material of the handle 12 and the head 16 or a tunnel passage therethrough.

In those instances wherein the violet light source or sources 26A are located in the head 16, the violet light source(s) 26A will typically be provided with electrical power from one or more batteries 32 located within an internal cavity 36 of the handle 12 and the supply of electrical power to the violet light source or sources 26A will typically be controlled by a switch 38, e.g., a “on/off” switch or an a “on” switch with the toothbrush being turned “off” by the control circuitry 42, located at an appropriate position on the handle 12. The circuitry will further include leads 32L running from the handle 12 and through the neck to the head 16 and the leads 32L will typically include appropriate electrical connectors 34L at junction 34 which facilitate repeated disconnection and reconnection in a reliable manner.

In this regard, it should be noted that batteries 32 may be of any type meeting the power, storage and/or size requirements while still being small enough to reside in within the handle 12 and to provide the necessary levels of current to the violet light sources 20 for the required duration, such a NiCad, NiMiH, lithium ion, or lithium polymer batteries which typically may be rechargeable by electrical current supplied from a wall socket. For this reason, the handle 12 may also include a charging circuit 32C that can be connected to a direct or indirect source of electrical current supplied from a conventional wall socket, such as by a connector or by an induction coupling device. An active and passive interlock system will be employed to prevent normal operation during battery recharge. This interlock system may consist of mechanical keying of electrical connections and or electronic control of the toothbrush electronics by the charging circuit. It should also be noted that advances in battery technology may allow one or more batteries 32 to be located within the handle 12 to facilitate the use of interchangeable heads 16, with the corresponding connections for the switch 38 and the recharging circuits 32C passing through the neck 28 to the handle 12. As an alternative source, the power source or batteries may be AA or AAA alkaline, lithium, or carbon zinc batteries which are commercially available and readily replaceable by the user of the toothbrush.

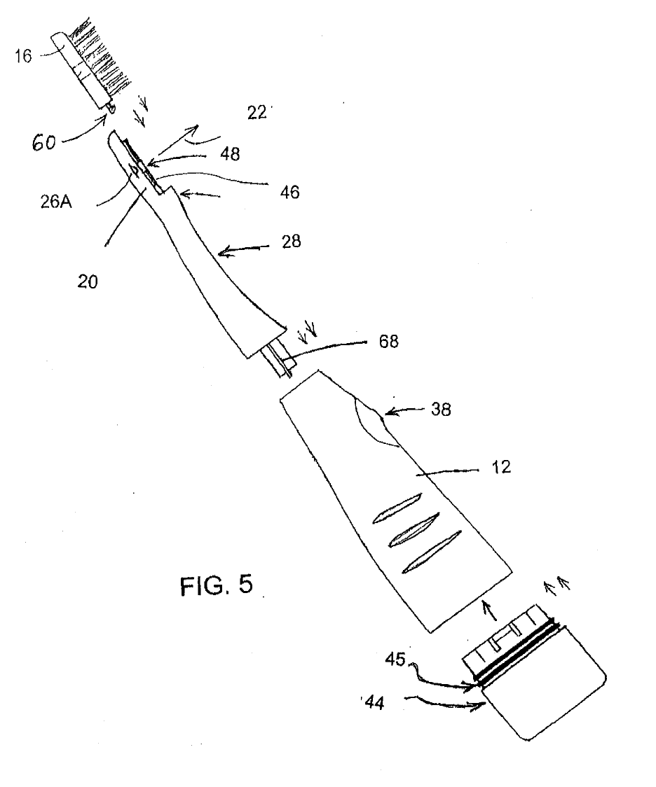

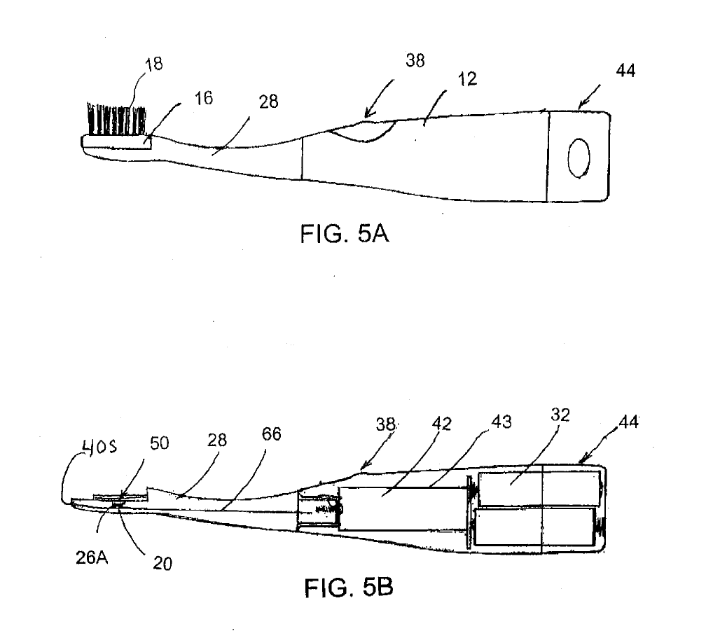

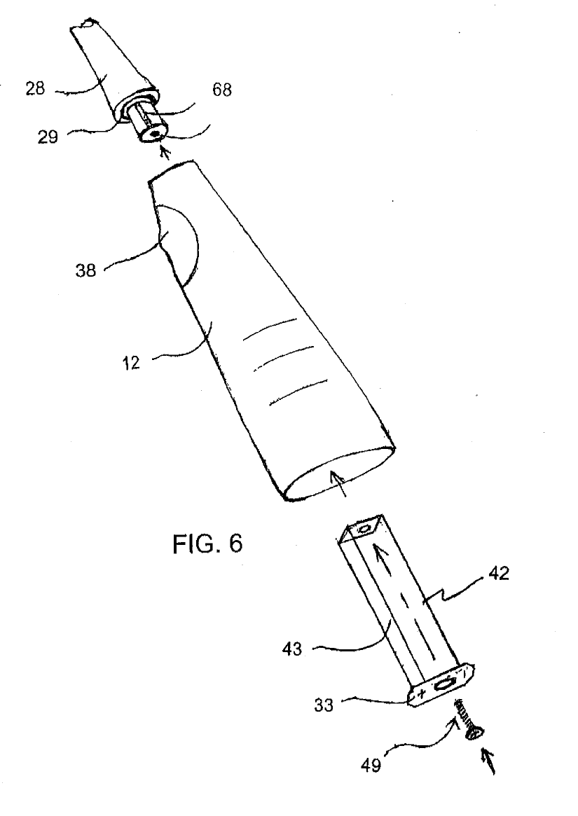

Turning now to FIG. 5 through FIG. 8B, a further embodiment of a solely toothbrush, except for the electrically power light source 26A, is shown and will be now described. According to this embodiment, the toothbrush generally comprises a handle 12 which has a neck 28 securely affixed to one end thereof, e.g., by a snap in self-locking engagement or connection, an adhesive, etc. Typically at least one seal 29, such as a silicon O-ring, is located at the interface (see FIG. 6) of the neck 28 with the handle 12 for preventing any water, moisture, toothpaste or any other contaminant from entering therebetween. An interior area or compartment of the handle 12 contains the control circuitry 42, which is carried by a removal circuit board 43 (see FIGS. 5B and 6), which generates a desired intensity and duration of the violet light 22, e.g., a timed “on/off” operation of the light source for two (2) minutes for example, as well as a power source such as a pair of AA batteries 32 for powering the control circuitry 42 for powering the violet light source 26A. A further detailed discussion concerning the attributes of the control circuitry 42 will follow below.

To facilitate turning the control circuitry 42 “on” for a timed duration, the exterior surface of the handle 12 is provided with an activation switch 38. The end of the handle 12, opposite from the neck 28, has a removable cover 44 which facilitates both replacing the batteries 32, when necessary, as well as installation of the board 43 within a base section of the handle 12 by a fastener 49, such as a screw. One or more seals 45, such as a silicon O-ring, is located on a leading end of the removable cover 44 for preventing any water, moisture, toothpaste or any other contaminant from entering between the handle 12 and the removable cover 44.

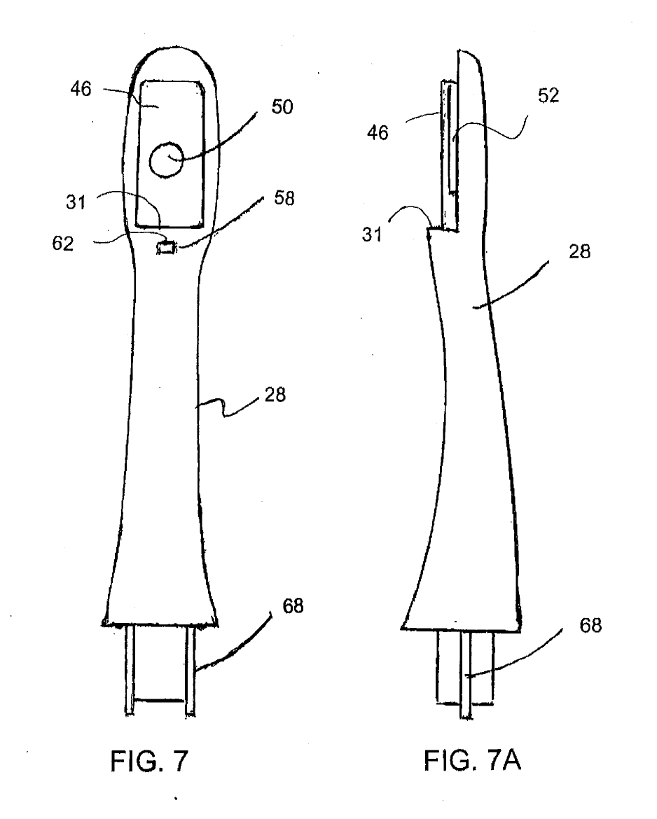

As can be seen in FIGS. 5, 5B, 7 and 7A, the free end of the neck 28 has a planar brush head receiving surface 46 which mates with the replaceable brush head 16 and a further description concerning the same will follow below. An opening 48 is formed in this receiving surface 46 and a “violet light” source 26A, such as violet light emitting diode or violet light emitting organic light emitting diode, is located within and completely fills the opening 48 in the receiving surface 46. A fluid tight seal is formed between the outer perimeter of exterior surface of the light emitting source or diode 26A and the inner perimeter surface of the opening 48 in the receiving surface 46 to prevent any water, moisture, toothpaste or any other contaminant from entering, between the interface between those components, into an interior area of the neck 28. For example, the outer perimeter of exterior surface of the light emitting source or diode can be welded, glue, etc. to the inner perimeter surface of the opening 48 to form the fluid tight seal therebetween. To further assist with preventing any water, moisture, toothpaste or any other contaminant from hindering operation of the control circuitry 42, the control circuitry 42 is spaced from the opening 48 in the receiving surface 46 by a remainder of the neck 28, e.g., between about 1 and 3 inches for example, and completely accommodated within the handle 12.

As can be seen in FIGS. 5, 5B and 7A, the light emitting surface 50 of the light emitting source 26A is preferably slightly recessed below the planar receiving surface 46 of the neck 28 so as not hinder sliding movement of the replaceable brush head 16 relative to the neck 28 and thereby facilitate replacement of the replaceable brush head 16 when required, as will be discussed below in further detail.

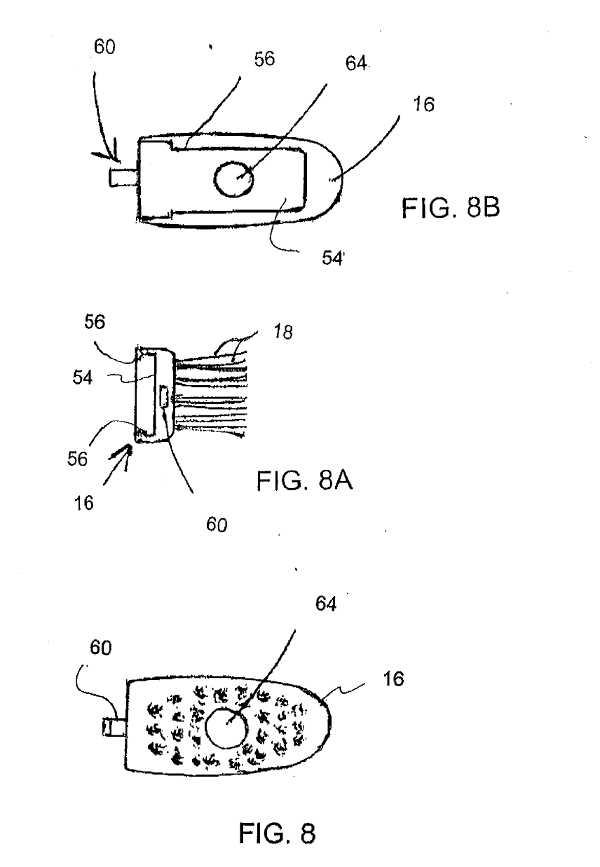

To facilitate secure attachment as well as replacement of the replaceable brush head 16, a U-shaped annular groove 52 is formed in a sidewall of the receiving surface 46 and this U-shaped annular groove 52 extends around three (3) adjacent sides of the receiving surface 46 of the neck 28 (see FIGS. 5 and 6A). A bottom surface of the replaceable brush head 16 is provided with a downwardly facing mating flat surface 54 (see FIGS. 8A and 8B) which mates with and slides along the upwardly facing receiving surface 46 of the neck 28. A U-shaped protrusion 56 is formed in a sidewall extending normal to the mating flat surface 54 and this U-shaped protrusion 56 extends around three (3) adjacent sides of the mating flat surface 54 of the replaceable brush head 16. When the replaceable brush head 16 is placed on the receiving surface 46 such that the mating flat surface 54 engages with the receiving surface 46 and the replaceable brush head 16 is slide toward the handle 12, the U-shaped protrusion 56 is received by and mates with the U-shaped annular groove 52 of the neck 28 to secure the replaceable brush head 16 to the neck 28. That is, as the flat bottom surface of the replaceable brush head 16 slides along the upwardly facing flat face of the neck 28, the U-shaped protrusion 56 of the replaceable brush head 16 is received within the U-shaped annular groove 52 of the neck 28 and this facilitates a locking engagement between the replaceable brush head 16 and the neck 28.

In order to retain the relative locked position, between the replaceable brush head 16 and the neck 28, an end wall 31 of the neck 28 has a passageway 58 which opens to the external environment while a leading end of the replaceable brush head 16 has a spring clip 60 which is positioned to be aligned with and sized to readily pass through the passageway 58 and latch onto a latching surface 62 of the passageway 58 which is formed where the passageway 58 opens to the external environment and, once the clip 60 latches with the latching surface 62 of the passageway 58, such latching engagement captively retains the replaceable brush head 16 on the neck 28 during normal use of the toothbrush. In order to remove the replaceable brush head 16 from the neck 28, the user must bias the remote end of the clip 60 out of engagement with the latching surface 62 while, at the same time, sliding or moving the replaceable brush head 16 away from the end wall of the neck 28 until the clip 60 is clear of the latching surface 62. Once this occurs, the user then continues sliding the replaceable brush head 16 away from the end wall until the U-shaped protrusion 56 completely disengages from the U-shaped annular groove 52. Thereafter, a new replaceable brush head 16 is then secured to the neck 28 by reversing the above procedure.

Each replaceable brush head 16 has an aperture 64 formed in a base surface thereof and this aperture 64, once the replaceable brush head 16 is securely attached to the neck 28 such that the clip 60 engages with the latching surface 62, is properly aligned with the light emitting source 26A secured within the opening 48 in the receiving surface 46 of the neck 28 so that the aperture 64 in the replaceable brush head 16 precisely overlies and is concentric with the light emitting source 26A. Preferably, the aperture 64 is slightly larger in size than the light emitting source 26A so as to permit all of the violet light 22, emitted from the light emitting source 26A, to pass readily through the aperture 64 and treat the teeth, gums and mouth of the individual utilizing the toothbrush during brushing.

The exterior upwardly facing surface of the replaceable brush head 16, which is opposite to the mating flat surface 54, is provided with a plurality of bristles 18 and the base of each of the plurality of bristles 18 is securely embedded and permanently affixed to the replaceable brush head 16 so that the bristles 18 remain permanently attached to the replaceable brush head 16. Preferably, a plurality of bristles 18 are grouped together in a clump and each clump of bristles 18 is spaced from one another and located about the aperture 64 provided in the replaceable brush head 16. As is well known in the art, some or all of the bristles 18 may be coated with a wear indicator which indicates to the end user when it is time to replace the replaceable brush head 16.

Once the bristles 18 of the replaceable brush head 16 become sufficiently worn, the user removes the replaceable brush head 16 by dislodging the clip 60 from its engagement with the latching surface 62 and sliding the replaceable brush head 16 away from the end wall and the handle 12 until the replaceable brush head 16 becomes completely separated from the neck 28. Thereafter, the user inserts a new replaceable brush head 16 onto the neck 28 so that the clip 60 passes through the passageway 58 and engages with the latching surface 62 of the neck 28 and the aperture 64 of the replaceable brush head 16 is aligned with the light emitting source 26A.

It will be noted in the above embodiment of the light emitting toothbrush 10 that the violet light emitter 20 is located in the remote end of the neck 28. As a result of this, the electrical power from the power source, such as the batteries 32 and the electrical circuitry 42, to the violet light emitter 20 must be conducted from the handle 12 and through the neck 28 to the violet light emitter 20 located within the neck 28. To facilitate such conduction, a pair of electrical leads 66 are embedded within the neck 28 and each electrical lead is connected to the violet light emitter 20 in a conventional manner. The opposite end of each electrical lead terminates in a respective pin 68. The control circuitry 42 is support by the plug-in board 43 which is accommodated within the handle 12 such that a pair of pin apertures (not shown in detail) are located at the leading end of the board 43 and arranged to receive and mate with a respective one of the pins 68 connected to the violet light emitter 20 when the neck 28 is attached to the handle 12 and thereby complete the electrical circuit for powering the violet light emitter 20. As can be seen in FIG. 6, the trailing end of the plug in board 43 has a pair of spaced apart “+” and “−” contacts 33 which are located to mate with the respective “+” and “−” contacts of the batteries 32.

The light emitting toothbrush 10, according to the present invention, will typically further include a control circuitry 42 which will typically be located in the handle 12 and normally include functions such as a timer circuitry, which times the duration(s) of use of the toothbrush 10 while brushing, an on/off duty cycle of the violet light source or sources 26A, a replace battery indicator, and so on. Preferably the driver, for driving the violet light source 26A, is equipped with constant electrical current control electronics and a suitable driver is supplied by Linear Technology, of San Jose Calif., as part no. LTC3454 which is an integrated circuit high current LED driver. The control circuitry 42 may also include violet light source 26A control circuitry, which may be connected with one or more sensors 40S (see FIG. 5B), located in the neck 28, for detecting when the neck 28 is actually located within a user's mouth, thereby reducing the possibility of the violet light being inadvertently emitted except when the toothbrush is actually located within the mouth of the user. The sensor(s) 40S could include, for example, sensors for measuring or detecting conductivity, temperature, ambient light, or some other parameter indicating that the head 16 is in the mouth of a user, and the handle 12 may include a sensor for sensing the warmth or pressure of the user's hand before the violet light source or sources 20 can be activated.

It should also be noted that the toothbrush 10 may further include a motor (not shown) which moves, vibrates and/or rotates the head 16 in the manner of conventional powered toothbrushes, which may, in turn effect the arrangements for supplying the violet light 22 to the violet light emitters 20 in as much as the mechanical structure between the handle 12 and the head 16 in such toothbrushes includes a moving mechanical joint. In such implementations, therefore, it may be preferable to place the violet light source or sources 26A in the handle 12 and communicate the violet light 22 to the violet light emitters 20 in the head 16 by optical paths that are typically less affected by moving mechanical joints than are electrical conductors.

Lastly, it should be noted that the provision of the replaceable head 16 permits the use of other forms of violet light emitting heads 16 containing violet light emitters 20 as described herein above, but shaped for other purposes than specifically as a toothbrush, such as a wand specifically designed and/or intended for violet light irradiation of a photocatalytic agent distributed on the surfaces of the teeth and the gums. In a further example of an alternate arrangement of the head 16, the head 16 may be designed to hold and manipulate flossing thread or string, thereby allowing flossing to be carried out at the same time as a violet light photocatalytic process.

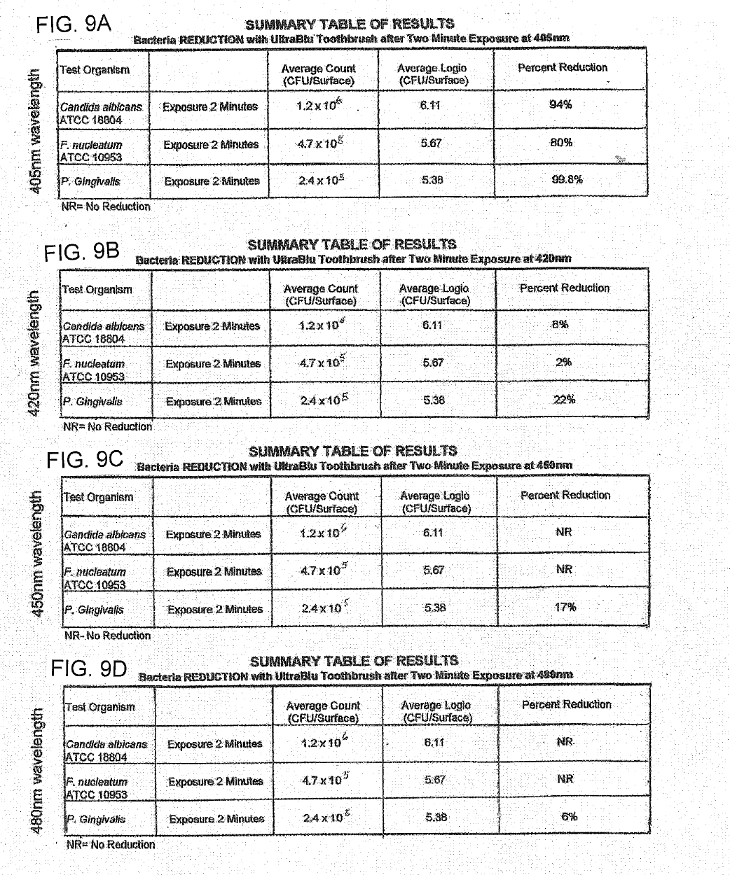

With reference now to tables shown in FIGS. 9A through 9D, the effectiveness of rapid germicidal (kill time) activity for a toothbrush, in accordance with the present invention, will now be discussed. In order to evaluate the effectiveness of different wavelengths of blue and violet light, the inventors instituted a study in which wavelengths of 405 nm, 420 nm, 450 nm and 480 nm were tested and compared to one another. The purpose of the study was to evaluate the antibacterial properties of each one of these different wavelengths of light.

During the study, test organisms commonly present in human saliva, such as Candida alibicans, ATCC 18804, Fusobacterium nucelatum, ATCC 10953 and Porphyromonas gingivalis, ATCC 22277, were collected from healthy human volunteers. Thereafter, each of these collected test organisms was quantified and then exposed to the light emitted from a toothbrush, according to the present invention, for a duration of 2 minutes at wavelengths of 405 nm, 420 nm, 450 nm and 480 nm. Finally, the effectiveness of treating the test organisms was determined and the results of each one of these tests are shown in FIGS. 9A-9D.

When performing this study, four glass surfaces were inoculated with a pooled human saliva and other test microorganisms that were collected from the human volunteers. Thereafter, the amount of test microorganisms on each one of inoculated glass surfaces was determined and then each one of the inoculated glass surfaces, with the test organisms, were exposed for duration of 2 minutes. The first glass surface was subjected to a wavelength of 405 nm, the second glass surface was subjected to a wavelength of 420 nm, the third glass surface was subjected to a wavelength of 450 nm and the fourth glass surface was subjected to a wavelength of 480 nm. Following completion of exposure of each one of the glass surfaces, the percent reduction in the original population of the test organisms was calculated and the results are shown in FIGS. FA-9D. Upon reviewing this data, it is readily apparent that a wavelength of 405 nm is much more effective in killing test organisms commonly present in human saliva than wavelength of 420 nm, a wavelength of 420 nm is generally more effective in killing test organisms commonly present in human saliva than a wavelength of 450 nm, and a wavelength of 450 nm is generally more effective in killing test organisms commonly present in human saliva than a wavelength of 480 nm. That is, a wavelength of about 405 nm is shown to be the most effective wavelength of light in killing test organisms, such as Candida alibicans, ATCC 18804, Fusobacterium nucelatum, ATCC 10953 and Porphyromonas gingivalis, ATCC 22277, which are commonly present in human saliva. Although wavelength of below 400 nm, may be effective as well, it is to be appreciated that such wavelengths, at any power level, are typically capable of damaging human skin including the tissue of human eyes. Moreover, UV light within this wavelength range is nearly invisible to a user or patient so that it is difficult to determine where the emitted UV beam is directed or aimed. Accordingly, the present invention is directed at violet light of about 405 nm which is generally not capable of damaging human skin and is also generally visible to a user or patient to facilitate safe and proper use of the toothbrush.

In summation, the inventors have determined that a wavelength of 405 nm+/−5 nm is most effective in killing test organisms commonly present in human saliva and at an average power level of less than 5 watts. According to a more preferred form of the present invention, a wavelength of between 400 nm and 415 nm between 400 nm and 420 nm is effective in killing test organisms commonly present in human saliva and at an average power level of less than 5 watts and such wavelength range is generally not capable of damaging human skin and is also generally visible to a user or patient to facilitate safe and proper use of the toothbrush.

It will be appreciated that various changes and/or modifications to the present invention may be made by those of ordinary skill in the art without departing from the spirit and scope of the present invention which is set out in more particular detail in the appended claims. Furthermore, those of ordinary skill in the art will appreciate that the foregoing description is supplied by way of example only, and is not intended to be limiting of the invention as described in the appended claims.

Wherefore, I/We claim:

1. A toothbrush having a light source which facilitates a photocatalysis process while brushing, the toothbrush comprising:
a handle having a grip at a proximal end and a neck at a distal end thereof, the distal end of the neck having an opening therein, and a violet light emitting source being located within the opening for emitting violet light in a direction generally normal to the neck and the handle;
a completely replaceable brush head having an aperture formed therein and at least one group of bristles being permanently secured to the replaceable brush head, and the aperture of the replaceable brush head, once the replaceable brush head is installed on neck, overlies and is concentric with the violet light emitting source to permit the violet light to pass though the aperture and be emitted generally parallel to the bristles;
a power source for energizing the violet light emitting source and for radiating violet light in a wavelength band between 400 nm to 420 nm; and
a perimeter of a violet light emitting surface of the violet light emitting source being sealed with respect to the opening to form a fluid tight seal therewith to prevent any water, moisture, toothpaste or other contaminant from entering therebetween.

2. The toothbrush having the light source which facilitates the photocatalysis process while brushing according to claim 1, wherein the neck has a planar brush head receiving surface and the opening is formed therein, and the emitting surface of the violet light source completely fills the opening and is recessed below receiving surface so as not hinder sliding movement of the replaceable brush head relative to the neck and thereby facilitate replacement of the replaceable brush head.

3. The toothbrush having the light source which facilitates the photocatalysis process while brushing according to claim 1, wherein a U-shaped annular groove is formed in a sidewall of the receiving surface and the U-shaped annular groove extends around three adjacent sides of the receiving surface of the neck, and the replaceable brush head has a mating flat surface which mates with and slides along the receiving surface of the neck, and the replaceable brush head has a mating U-shaped protrusion which is received by the U-shaped annular groove to secure the replaceable brush head to the neck.

4. The toothbrush having the light source which facilitates the photocatalysis process while brushing according to claim 3, wherein the neck has a passageway while a leading end of the replaceable brush head has a clip which is aligned with and sized to readily pass through the passageway, and the clip latches with a latching surface of the passageway to captively retain the replaceable brush head on the neck during use of the toothbrush.

5. The toothbrush having the light source which facilitates the photocatalysis process while brushing according to claim 4, wherein the aperture of the replaceable brush head is larger in size than the violet light emitting source.

6. The toothbrush having the light source which facilitates the photocatalysis process while brushing according to claim 1, wherein the replaceable brush head supports a plurality of bristles and a base of each of the plurality of bristles is embedded within the replaceable brush head so that the bristles remain permanently attached to the replaceable brush head.

7. The toothbrush having the light source which facilitates the photocatalysis process while brushing according to claim 6, a plurality of bristles are grouped together into a plurality of clumps of bristles and the plurality of clumps of bristles are spaced from one another and located about the aperture of the replaceable brush head.

8. The toothbrush having the light source which facilitates the photocatalysis process while brushing according to claim 1, wherein the violet light radiated by the violet light source has an average power level of less than 1 watt.

9. The toothbrush having the light source which facilitates the photocatalysis process while brushing according to claim 8, wherein the violet light radiated by the violet light source is a continuous violet light emission.

10. The toothbrush having the light source which facilitates the photocatalysis process while brushing according to claim 8, wherein the violet light radiated by the violet light source is a modulated violet light emission.

11. The toothbrush having the light source which facilitates the photocatalysis process while brushing according to claim 10, wherein the modulated violet light emission is at a frequency of between about 6 and about 60 Hertz.

12. The toothbrush having the light source which facilitates the photocatalysis process while brushing according to claim 1, wherein the violet light radiated by the at least one violet light source comprises a combination of a continuous violet light emission and a modulated violet light emission and the combination violet light emission has an average power level of less than 5 watts.

13. The toothbrush having the light source which facilitates the photocatalysis process while brushing according to claim 1, wherein the photocatalytic agent is one of a modified TiO₂ semiconductor type materials, a catalytic n-type semiconductor material, and an organic dye which photocatalytically responsive to violet light radiation.

14. The toothbrush having the light source which facilitates the photocatalysis process while brushing according to claim 1, wherein the power source is one of a non-rechargeable battery and a rechargeable battery.

15. A toothbrush having a light source which facilitates a photocatalysis process while brushing, the toothbrush comprising:
a handle having a grip at a proximal end and a neck at a distal end thereof, the distal end of the neck having opening therein, and a violet light emitting source being located within the opening for emitting violet light in a direction generally normal to the neck and the handle;
a completely replaceable brush head having an aperture formed therein and at least one group of bristles being permanently secured to the replaceable brush head, and the aperture of the replaceable brush head, once the replaceable brush head is installed on neck, overlies and is concentric with the violet light emitting source to permit the violet light to pass though the aperture and be emitted generally parallel to the bristles;
a power source equipped with constant electrical current control electronics for energizing the violet light source and for radiating violet light with the violet light being modulated from 0% to 100% at a frequency of between a two (2) and two hundred (200) Hertz with an average optical output power level of less than 5 watts for radiating violet light in a wavelength band of about 410 nm;
a perimeter surface of the violet light emitting source being sealed with respect to the opening to form a fluid tight seal therewith; and
the handle at least partially accommodating at least one of control circuitry and a power source for the violet light source.

16. The toothbrush having the light source which facilitates the photocatalysis process while brushing according to claim 15, wherein the neck has a planar brush head receiving surface and the opening is formed therein, and the emitting surface of the violet light source completely fills the opening and is recessed below receiving surface so as not hinder sliding movement of the replaceable brush head relative to the neck and thereby facilitate replacement of the replaceable brush head.

17. The toothbrush having the light source which facilitates the photocatalysis process while brushing according to claim 16, wherein a U-shaped annular groove is formed in a sidewall of the receiving surface and the U-shaped annular groove extends around three adjacent sides of the receiving surface of the neck, and the replaceable brush head has a mating flat surface which mates with and slides along the receiving surface of the neck, and the replaceable brush head has a mating U-shaped protrusion which is received by the U-shaped annular groove to secure the replaceable brush head to the neck.

18. The toothbrush having the light source which facilitates the photocatalysis process while brushing according to claim 15, wherein the neck has a passageway while a leading end of the replaceable brush head has a clip which is aligned with and sized to readily pass through the passageway, and the clip latches with a latching surface of the passageway to captively retain the replaceable brush head on the neck during use of the toothbrush; and
the aperture of the replaceable brush head is larger in size than the violet light emitting source and the replaceable brush head supports a plurality of bristles and a base of each of the plurality of bristles is embedded within the replaceable brush head so that the bristles remain permanently attached to the replaceable brush head.

19. The toothbrush having the light source which facilitates the photocatalysis process while brushing according to claim 15, wherein the violet light radiated by the at violet light source comprises a violet light emission wherein the modulated violet light emission is modulated at a frequency of between about 6 and about 60 Hertz.

20. A method of forming a toothbrush having a light source which facilitates a photocatalysis process while brushing, the method comprising the steps of:
providing a handle having a grip at a proximal end and a neck at a distal end thereof, forming an opening in the distal end of the neck, and locating a violet light emitting source within the opening for emitting violet light in a direction generally normal to the neck and the handle;
forming an aperture in a completely replaceable brush head and permanently securing at least one group of bristles to the replaceable brush head, and installing the replaceable brush head on the neck so that the aperture overlies and is concentric with the violet light emitting source to permit the violet light to pass though the aperture and be emitted generally parallel to the bristles;
energizing the violet light source with a power source for radiating violet light which is modulated from 0% to 100% at a frequency of between a two (2) and two hundred (200) Hertz with an average optical output power level of less than 5 watts for radiating violet light in a wavelength band between 400 nm to 420 nm;
sealing a perimeter surface of the violet light emitting source with respect to the opening to form a fluid tight seal therewith; and
at least partially accommodating, within the handle, at least one of control circuitry and a power source for the violet light source.
